(19) United States
(12) Patent Application Publication
(10) Pub. No.: US 2010/0236434 A1
(43) Pub. Date: Sep. 23, 2010

(54) METHOD FOR PROVIDING A COATING (METAL-BACK PRINTING BLANKET) OF A TYPOGRAPHIC PRINTING ROLL WITH THERMO-ADHESIVE PLASTIC SHEET AS UNDERCOATING

(75) Inventors: Gianpietro Invernizzi, Lodi (IT); Fausto Zeni, Secugnago (IT)

Correspondence Address: FITCH EVEN TABIN & FLANNERY, 120 SOUTH LASALLE STREET, SUITE 1600, CHICAGO, IL, 60603-3406, US

(73) Assignee: Trelleborg Engineered Systems Italy S.P.A., Milano (IT)

(21) Appl. No.: 12/667,835

(22) PCT Filed: Jul. 4, 2008
(86) PCT No.: PCT/IB08/52699

§ 371 Date: Jun. 7, 2010

(30) Foreign Application Priority Data
Jul. 6, 2007 (IT) MI2007A001348

(51) Int. Cl. B41N 1/04; C09J 5/02; B29C 65/02

(52) U.S. Cl. 101/395; 156/308.6; 156/308.2

(57) ABSTRACT

Described herein is a method for providing a coating (metal-back printing blanket) of a typographic printing roll with a thermo-adhesive plastic sheet comprising the steps of: application of a layer of heat-sealable material on the side of the sheet of plastic material that will come into contact with the metal layer, and thermo-adhesion of the plastic sheet to the metal layer.

### FIELD OF APPLICATION OF THE INVENTION

The present invention relates to a method for providing a coating (metal-back printing blanket) of a typographic printing roll with thermo-adhesive plastic sheet as undercoating.

### STATE OF THE ART

Offset typographic printing machines are made up of a number of rolls, some of which simply carry out a driving function in regard to the paper that is passing through, whilst others are involved, in particular, in the printing process. Amongst the latter rolls, at least one performs the function of taking the ink from the printing plate or matrix and transferring it to the paper. The roll or cylinder that is to receive the ink from the plate and transfer it to the paper is made of steel coated with a rubberized fabric referred to in the technical sector as “offset printing blanket”, which is to guarantee that the ink is taken up efficiently from the printing matrix with a consequent good transfer of the ink itself to the paper to be printed.

An offset printing blanket is typically made up of different layers, generally of rubber and fabric; its outer part (top part) is made of rubber, and the bottom part in contact with the printing roll is generally made of fabric.

In the case, instead, of a coating referred to in the technical sector and in what follows as “metal-back printing blanket”, the bottom part in contact with the printing roll is constituted by a metal layer made of stainless steel.

The metal-back printing blanket is wound around the steel roll, which envisages a transverse slit, referred to as <<gap>>, within which the terminal edges of the metal base of the metal-back printing blanket are inserted and fixed.

The printing roll and the metal-back printing blanket wound around it are subject to phenomena of corrosion and wear due in part to mutual rubbing and in part to the corrosive action of the chemical substances used both in the printing process and in the steps of cleaning after use.

In order to overcome the effects of corrosion and wear, it is known from the patent No. U.S. Pat. No. 6,912,955 to coat the bottom surface of the metal-back printing blanket, which is to come into contact with the printing roll, with a plasma treatment.

It is likewise known to insert between the metal layer of the metal-back printing blanket and the surface of the printing roll a sheet of plastic material, which can be wound around the printing roll, or else fixed on the bottom surface of the metal layer of the blanket. Fixing is obtained with an adhesive of the acrylic PSA (Pressure Sensitive Adhesive) type.

Said adhesive, however, presents problems due to the fact that it does not resist effectively the solvents used in the processes of printing and cleaning and does not resist effectively temperatures higher than 60° C. The solvent tends to penetrate from the edges of the plastic sheet and corrode the adhesive, forming also bubbles and peeling of the coating. The most problematical consequence is that the plastic sheet tends to slide and displace with respect to the metal layer of the metal-back printing blanket, with consequent machine downtime for replacement of the metal-back printing blanket itself and consequent reduction in productivity.

### SUMMARY OF THE INVENTION

Consequently, the purpose of the present invention is to overcome the aforesaid drawbacks and indicate a method for providing a metal-back printing blanket with thermo-adhesive plastic sheet, which prevents penetration of the solvents and guarantees perfect adhesion of the plastic sheet to the metal surface of the metal-back printing blanket.

The subject of the present invention is a method for providing a coating for a typographic printing roll, said coating, referred to as “metal-back printing blanket”, comprising at least one metal layer, one or more upper layers, and a sheet of plastic material on the bottom surface of the metal layer, said method being characterized in that it comprises the steps of: application of a layer of heat-sealable material on the side of the sheet of plastic material that will come into contact with the metal layer, and/or on the side of the metal layer that will come into contact with the sheet of plastic material; thermo-adhesion of the plastic sheet to the metal layer.

A particular subject of the present invention is a method for providing a metal-back printing blanket with thermo-adhesive plastic undercoating, and corresponding metal-back printing blanket obtained as will be described more fully in the claims, which form an integral part of the present description.

### BRIEF DESCRIPTION OF THE FIGURES

Further purposes and advantages of the present invention will emerge clearly from the ensuing detailed description of an example of embodiment thereof (and of its variants) and from the annexed plate of drawings, which is provided purely by way of explanatory and non-limiting example, and in which:

FIG. 1 shows a cross-sectional side view of the metal-back printing blanket with a plastic-sheet undercoating, forming the subject of the present invention;

FIG. 2 shows a variant of the coating of FIG. 1.

### DETAILED DESCRIPTION OF EXAMPLES OF EMBODIMENT

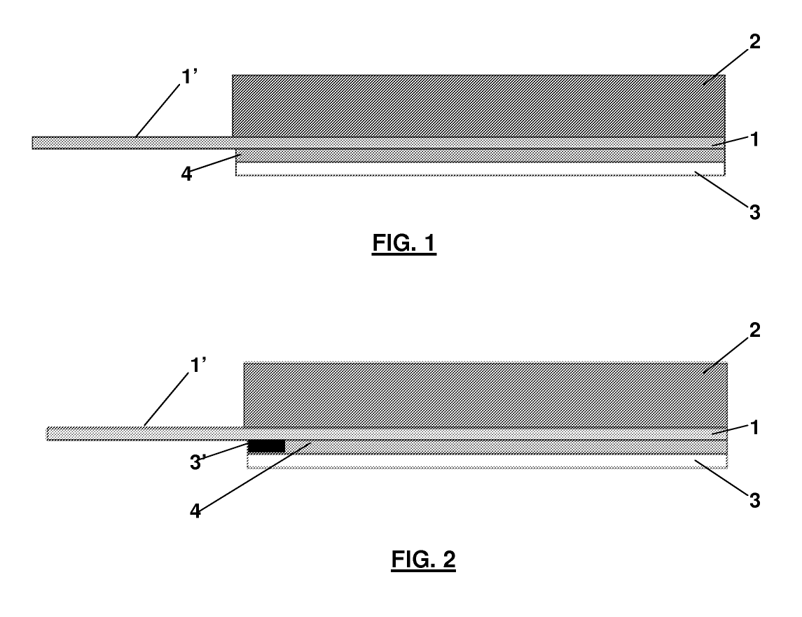

With reference to FIG. 1, the reference number 1 designates the metal layer of the metal-back printing blanket, whilst the reference number 2 designates the set of the upper layers of the metal-back printing blanket (one or more layers) obtained with well-known techniques.

The reference number 3 designates a sheet of plastic material, for example made of polyester, applied on the bottom surface of the metal layer 1 of the blanket. Preferably, the plastic sheet 3 occupies a major part of the bottom surface of the metal layer, with the exclusion of the edge 1′, which is folded back and inserted in the gap of the printing roll (not represented in the figure).

Then, according to the main aspect of the present invention, in a first variant, the side of the plastic sheet 3 that will come into contact with the metal layer 1 is coated with a layer 4 of heat-sealable material, which can comprise, for example, one or more of the following materials: thermoplastic polyurethane, polyvinyl chloride, copolymers with vinyl acetate, thermosetting polyurethane, polyester, polyimide, polyolephin, phenolic-resin-based films, epoxy adhesives, polyurethane adhesives, polyacrylic adhesives, etc.

With a normal process of thermo-adhesion, the plastic sheet 3 is made to adhere to the metal layer 1 by melting and adhesion of the heat-sealable material over its entire surface.

Said heat-sealable material proves resistant to the solvents typically used and to the high temperatures, higher than 60° C., which develop during normal use of the metal-back printing blanket.

Hence, in this way it is possible to avoid use of the adhesive of the acrylic PSA (Pressure Sensitive Adhesive) type.

Variants are possible to the non-limiting example described, without this implying any departure from the sphere of protection of the present invention, said variants comprising all the embodiments that are equivalent for a person skilled in the branch.

In accordance with a first variant, the layer 4 of heat-sealable material can be applied also or only on the side of the metal layer that will come into contact with the sheet of plastic material.

According to other possible variants, the layer 4 of heat-sealable material can be of a single-layer type with a composition of materials comprising one or more materials, for example chosen from amongst the ones referred to above, or else can be multilayer, with layers of different materials, for example chosen from amongst the ones referred to above.

A supplementary layer of a “primer” type can be applied, i.e., of a type in itself known and available on the market, used as thermo-adhesion promoter, and applied to the metal layer 1, or else also to the plastic sheet 3, prior to the application of the other heat-sealable layers. As further example of possible variants, the thermo-adhesion process may regard the entire surface of the plastic sheet 3, or else just the edges. In particular, it may regard just the edge 3′ (FIG. 2) of the plastic sheet set at the so-called “leading edge” of the metal-back printing blanket, i.e., at the edge that is in front with respect to the direction of rotation of the printing roll, at one side of the gap of the printing roll.

From the above description the person skilled in the branch is able to reproduce the subject of the invention without introducing any further constructional details.

1. A method for providing a coating for a typographic printing roll, said coating comprising at least one metal layer, one or more upper layers, and a sheet of plastic material on the bottom surface of the metal layer, said method comprising:
application of one or more layers of heat-sealable material on the side of the sheet of plastic material that will come into contact with the metal layer, and/or on the side of the metal layer that will come into contact with the sheet of plastic material; and
thermo-adhesion of the plastic sheet to the metal layer.

2. The method according to claim 1, wherein said heat-sealable material comprises one or more of the following materials: thermoplastic polyurethane, polyvinyl chloride, copolymers with vinyl acetate, thermosetting polyurethane, polyester, polyamide, polyolephin, phenolic-resin-based films, epoxy adhesives, polyurethane adhesives, polyacrylic adhesives.

3. The method according to claim 1, wherein said one or more layers of heat-sealable material are a single-layer with a composition of materials comprising one or more of said materials.

4. The method according to claim 1 wherein said one or more layers of heat-sealable material are a multilayer, with a composition of materials comprising one or more of said materials.

5. The method according to claim 3 wherein a supplementary layer of a primer type is applied, as thermo-adhesion promoter, said supplementary layer being applied to one of the metal layer and the plastic sheet, prior to application of the other heat-sealable layers.

6. The method according to claim 1, wherein said plastic sheet is applied on a major part of the bottom surface of the metal layer, with the exclusion of the edge, which is folded back and inserted in a gap provided in the typographic printing roll.

7. The method according to claim 1, wherein said step of thermo-adhesion regards the entire surface of the plastic sheet.

8. The method according to claim 1, wherein said step of thermo-adhesion regards just the edges of the plastic sheet.

9. A metal-back printing blanket, comprising at least one metal layer, one or more upper layers, and a sheet of plastic material on the bottom surface of the metal layer, said sheet of plastic material is coated with one or more layers of heat-sealable material on the side in contact with the metal layer, and/or the side of said metal layer is coated with one or more layers of heat-sealable material on the side of the metal layer that will come into contact with the sheet of plastic material, said sheet of plastic material being fixed by thermo-adhesion to the metal layer.

10. The metal-back printing blanket according to claim 9, wherein said heat-sealable material comprises one or more of the following materials: thermoplastic polyurethane, polyvinyl chloride, copolymers with vinyl acetate, thermosetting polyurethane, polyester, polyamide, polyolephin, phenolic-resin-based films, epoxy adhesives, polyurethane adhesives, polyacrylic adhesives.

11. The metal-back printing blanket according to claim 9 wherein said one or more layers of heat-sealable material are a single-layer, with a composition of materials comprising one or more of said materials.

12. The metal-back printing blanket according to claim 9, wherein said one or more layers of heat-sealable material are a multilayer, with a composition of materials comprising one or more of said materials.

13. The metal-back printing blanket according to claim 11, further comprising a supplementary layer of a primer type, as thermo-adhesion promoter, said supplementary layer being applied to one of the metal layer and the plastic sheet, prior to application of the other heat-sealable layers.

14. The metal-back printing blanket according to claim 9, wherein said plastic sheet is applied on a major part of the bottom surface of the metal layer, with the exclusion of the edge, which is folded back and inserted in a gap provided in the typographic printing roll.

15. The metal-back printing blanket according to claim 9, wherein said thermo-adhesion regards the entire surface of the plastic sheet.

16. The metal-back printing blanket according to claim 9, wherein said thermo-adhesion regards just the edges of the plastic sheet.

17. The method according to claim 4, wherein a supplementary layer of a primer type is applied, as thermo-adhesion promoter, said supplementary layer being applied to one of the metal layers prior to application of the other heat-sealable layers.

18. The metal-back printing blanket according to claim 12 further comprising a supplementary layer of a primer type, as thermo-adhesion promoter, said supplementary layer being applied to one of the metal layer and the plastic sheet, prior to application of the other heat-sealable layers.
